(19) United States
(12) Patent Application Publication
(10) Pub. No.: US 2013/0265418 A1
(43) Pub. Date: Oct. 10, 2013

(54) ALARM CHAIN BASED MONITORING DEVICE

(71) Applicants: CHIN-TENG LIN, New Taipei City (TW); Chao-Ting Hong, New Taipei City (TW)

(72) Inventors: CHIN-TENG LIN, New Taipei City (TW); Chao-Ting Hong, New Taipei City (TW)

(21) Appl. No.: 13/440,997

(22) Filed: Apr. 6, 2012

(51) Int. Cl. H04N 7/18

(52) U.S. Cl. 348/143; 348/E07.085

(57) ABSTRACT

An alarm chain based monitoring device includes an alarm chain module, which is in information connection with at least one photographing device and at least one display element in information connection with the photographing device. The alarm chain module includes a definition unit, a sensitivity unit, and an alarming unit. The photographing device generates an image that is then displayed by the display element. The definition unit generates an alarm chain that includes control nodes and can be curved in the image. The sensitivity unit defines detection sensitivity of the alarm chain. When an object moves across the alarm chain, the alarming unit issues at least one alarm message, whereby the curved alarm chain defined in the image allows the installation site not be subjected to constraint and reduces error triggering rate.

### TECHNICAL FIELD OF THE INVENTION

The present invention generally relates to a monitoring device, and more particularly to an alarm chain based monitoring device, which allows the installation site not to be subjected to any constraint and reduces error triggering rate through definition of a curved alarm chain in an image.

### DESCRIPTION OF THE PRIOR ART

Watching any object accessing a specific site through monitoring operation with inspection devices is commonly used in various applications, such as security and burglary guarding, entrance access, and evacuation of operation area. The conventional technique used involves a passive inspection process, which employs sensors to detect an object to be detected in an inspected environment. Based on the radiation (such as infrared radiation generated by human body) emitting from the surface temperature of the object to be detected or changes of environmental factors (such as air turbulence or image difference acquired through a camera) caused by a motion, information related to the object to be detected in the environment (such as location and size) can be calculated and this provides the conventional way of detecting motion.

The conventional motion detection method comprises an image pickup device, a monitor, a motion detector, a recording device, and an alarm device. When the motion detector detects an object is moving in the image captured by the image pickup device, the motion detector controls the alarm device to issue an alarm to notify security personnel or starting recording operation of a recording device, so that the security guards do not need to keep on watching the monitor and also help eliminating human error. However, such a motion detection method can only detect and inspect the whole image, making it not feasible to be installed in a site where random objects may move through the image. For example, when such a device is installed indoors or by a road, the alarm may get easily and undesirably triggered.

Thus, it is a challenge of the industry to improve such a problem.

### SUMMARY OF THE INVENTION

In view of such a problem, the present invention aims to provide an alarm chain based monitoring device that defines an alarm chain in an image that can be curved in an image in order to allow the installation site not to be constrained and reduce the error triggering rate.

An object of the present invention is to provide a curved alarm chain in an image taken in order to allow the installation site not to be constrained and reduce the error triggering rate.

To achieve the above object, the present invention comprises, structurally, an alarm chain module, which is in information connection with at least one photographing device and at least one display element in information connection with the photographing device. The alarm chain module is in information connection with a recording unit and a timing unit. The alarm chain module comprises a definition unit, a sensitivity unit, and an alarming unit. When the photographing device is operating to generate an image and transmits the image to the display element to be displayed thereon, the definition unit generates, in the image, at least one alarm chain that comprises a plurality of control nodes and can be curved. The sensitivity unit defines the detection sensitivity of the alarm chain. When an object moves across the alarm chain, the sensitivity unit signals the alarming unit to issue at least one alarm message to remind of detection of an object moving across the alarm chain. With such a technical solution, the problems of the conventional motion detection method that the conventional can only be installed in sites where no object may pass through the image in order to prevent error triggering can be overcome by providing a curved alarm chain in the image to allow the installation site not to subject to constraint and reduce the error triggering rate.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a preferred embodiment of the present invention.

FIG. 2 is a schematic view showing an alarm chain according to the preferred embodiment of the present invention.

FIG. 3 is a schematic view showing an alarming operation according to the preferred embodiment of the present invention.

FIG. 4 is a schematic view showing a tracking and comparison operation according to the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

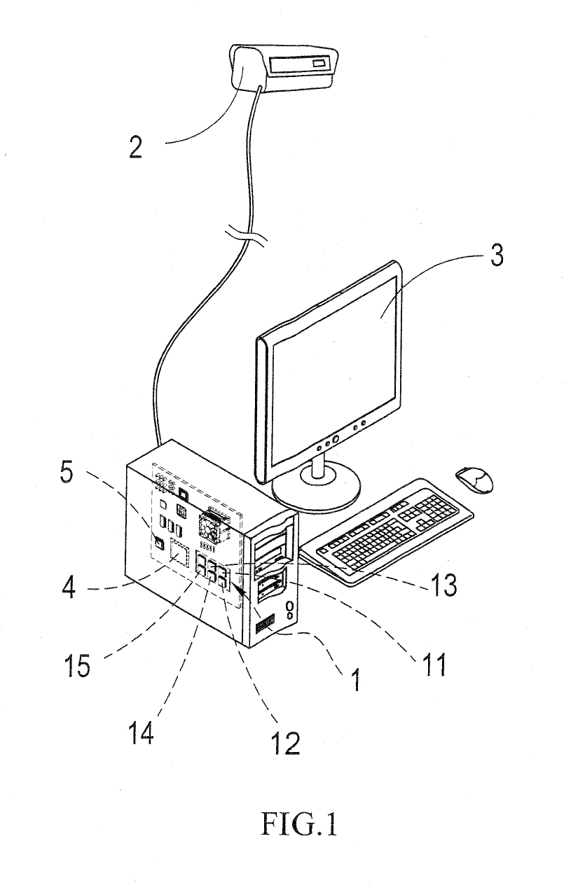

As shown in FIG. 1, a schematic view of a preferred embodiment of the present invention is shown. The drawing clearly shows that the present invention provides an alarm chain based monitoring device, which includes an alarm chain module 1, at least one photographing device 2, and at least one display element 3. The alarm chain module 1, the photographing device 2, and the display element 3 are in information connection with each other. The alarm chain module 1 is further in information connection with a recording unit 4 and a timing unit 5. The alarm chain module 1 comprises therein a definition unit 11, a sensitivity unit 12, an alarming unit 13, a tracking unit 14, and a comparison unit 15 that are in information connection.

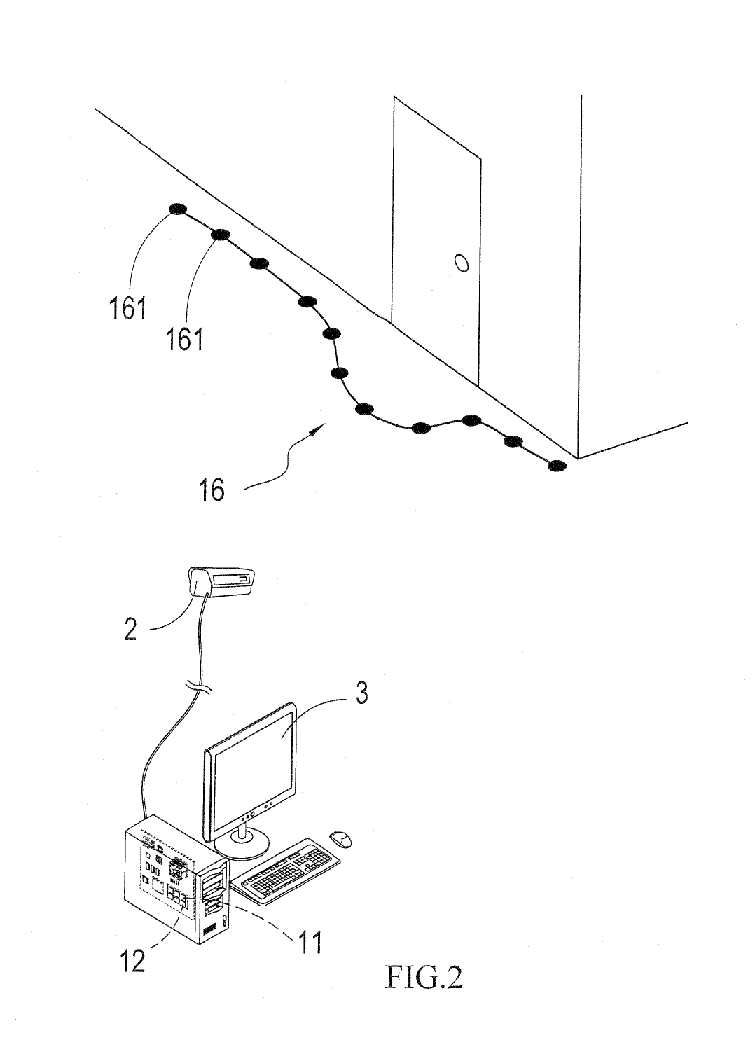

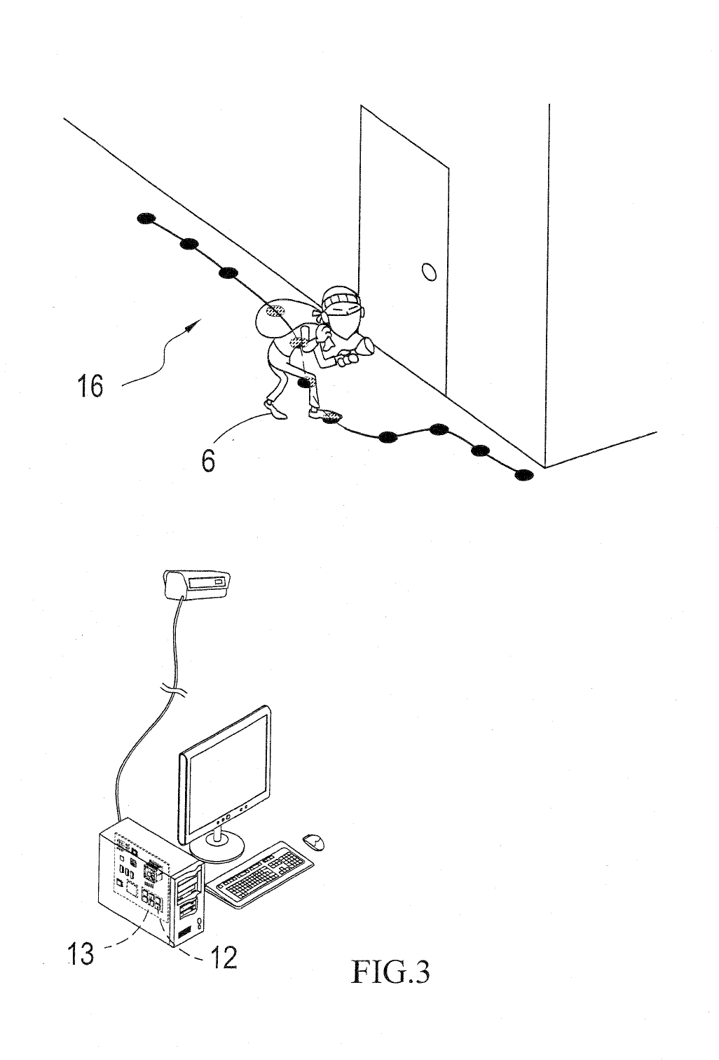

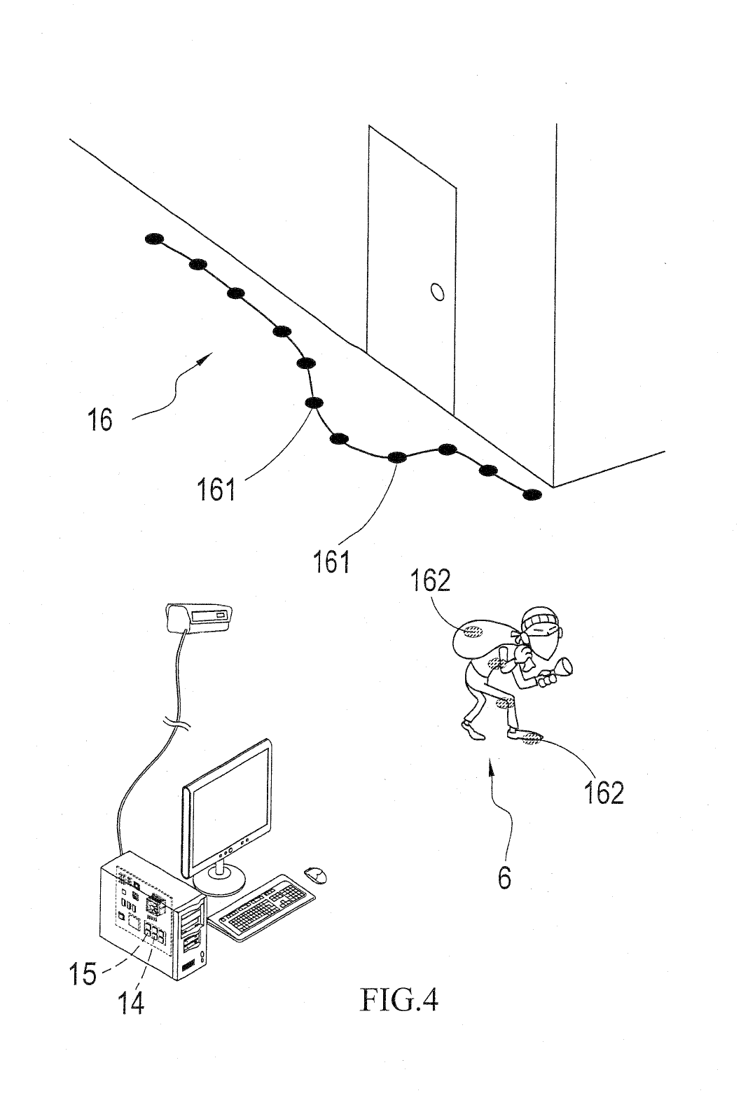

With the above arrangement, the operation of the present invention will be described as follows with reference to FIGS. 1-4, which are respectively a schematic view showing a preferred embodiment of the present invention, a schematic view showing an alarm chain, a schematic view showing an alarming operation, and a schematic view showing a tracking and comparison operation. These drawings clearly show that when the photographing device 2 is operating to generate an image and transmitting the image to the display element 3 to be displayed thereon, the definition unit 11 generates at least one alarm chain 16, which comprises a plurality of control nodes 161 and can be arranged in a curved form, in the image. The definition unit 11 functions to define starting and ending points, twisting points, node density, and curve equation of the alarm chain 16 to provide variety and flexibility of alarm rang. The sensitivity unit 12 functions to set detection sensitivity of the alarm chain 16, which, in combination with installation environment, helps improve accuracy (as shown in FIG. 2), whereby when an object 6 moves across the alarm chain 16, the sensitivity unit 12 makes a detection and signals the alarming unit 13 to issue at least one alarm message to remind of the detection of an object 6 moving across the alarm chain 16 (as shown in FIG. 3). The object 6, when moving across the alarm chain 16, passes the control nodes 161, and the control nodes 161 makes the tracking unit 14 generating virtual adhesive particles 162, which is attached, in a virtual manner, to the object 6 in order to track the movement of the object 6 and transmit further images of the object 6 to the comparison unit 15 for comparison for determining what is the object 6 (as shown in FIG. 4).

The above description illustrates only a preferred embodiment of the present invention and is not intended to impose unduly constraints to the scope of the present invention. Any simple modification or equivalent variation of the disclosure made therein and in the drawings is considered within the scope of the present invention.

Referring to all the drawings, compared to the conventional techniques, the present invention provides the following advantages:

(1) The alarm chain module 1 defines an alarm chain 16 that comprises a plurality of control nodes 161 and can be arranged in a curved form, whereby definition of a curved alarm chain in the image allows the installation site to be not subjected to constraint and reduces error triggering rate.

(2) The cooperative operations among the definition unit 11, the tracking unit 14, and the comparison unit 15 allows the present invention to realize tracking, comparison, and analysis of an object 6 that moves across the alarm chain 16

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An alarm chain based monitoring device, comprising:
at least one photographing device, which generates an image; and
an alarm chain module, which is in information connection with the photographing device, the alarm chain module providing the image with an alarm chain that comprises a plurality of control nodes and is selectively set in a curved form.

2. The alarm chain based monitoring device according to claim 1, wherein the photographing device is in information connection with a display element that displays the image, the display element being in information connection with the alarm chain module.

3. The alarm chain based monitoring device according to claim 1, wherein the alarm chain module comprises a definition unit, which provides the image with the alarm chain that comprises a plurality of control nodes and is selectively set in a curved form.

4. The alarm chain based monitoring device according to claim 3, wherein the definition unit defines staring and ending points, twisting points, node density, and curve equation of the alarm chain.

5. The alarm chain based monitoring device according to claim 3, wherein the alarm chain module is in information connection with a recording unit and a timing unit.

6. The alarm chain based monitoring device according to claim 3, wherein the definition unit is in information connection with an alarming unit that is contained in the alarm chain module.

7. The alarm chain based monitoring device according to claim 3, wherein the definition unit is in information connection with a sensitivity unit that is contained in the alarm chain module.

8. The alarm chain based monitoring device according to claim 3, wherein the definition unit is in information connection with a tracking unit that is contained in the alarm chain module.

9. The alarm chain based monitoring device according to claim 8, wherein the tracking unit is in information connection with a comparison unit contained in the alarm chain module.
